(19) United States
(12) Patent Application Publication
(10) Pub. No.: US 2024/0403618 A1
(43) Pub. Date: Dec. 5, 2024

(54) PERFORMING DYNAMIC SPARSE COMPUTATION ON DENSE COMPUTATION-EFFICIENT COMPUTING DEVICES

(71) Applicant: Microsoft Technology Licensing, LLC, Redmond, WA (US)

(72) Inventors: Ningxin ZHENG, Shanghai (CN); Huiqiang JIANG, Shanghai (CN); Quanlu ZHANG, Beijing (CN); Yuqing YANG, Shanghai (CN); Lingxiao MA, Beijing (CN); Zhenhua HAN, Shanghai (CN); Lili QIU, Shanghai (CN); Fan YANG, Beijing (CN); Mao YANG, Beijing (CN); Lidong ZHOU, Beijing (CN)

(21) Appl. No.: 18/325,790

(22) Filed: May 30, 2023

(51) Int. Cl. G06N 3/0495

(52) U.S. Cl. CPC G06N 3/0495

(57) ABSTRACT

Embodiments of the present disclosure include techniques processing dynamically sparse neural networks as dense computations. A permutation is performed to translate an input tensor from a sparse format into a dense format. Once in a dense format, dense computation can be performed to generate output data that is also in the dense format. A reverse permutation may then be performed to translate the output data back into the sparse format. An analysis of the operator is performed prior to runtime to determine the one or more dimensions of the tensor expression associated with the operator that are permutation invariant. The permutation may permutate the input tensor across dimensions that are permutation invariant.

### BACKGROUND

The present disclosure relates generally to neural networks. More particularly, the present disclosure relates to cost effective approach to accelerate neural networks by processing sparse data on dense computation-efficient computing devices such as accelerators.

A neural network is a machine learning model used for a variety of different applications (e.g., image classification, computer vision, natural language processing, speech recognition, writing recognition, etc.). A neural network may be trained for a particular purpose by running datasets through it, comparing results from the neural network to known results, and updating the network based on the differences.

Neural networks are generally executed on commodity accelerators such as GPUs and TPUs which are mainly designed for efficient dense computations. These commodity accelerators perform poorly on neural networks with dynamic sparsity where the sparsity patterns of the input data are dynamically discovered at runtime. For example, the input sentences of a natural language processing model have varied lengths so the sparsity patterns of the input data are discovered at runtime. The present disclosure includes techniques for improving the computation of sparse data on computing devices designed for dense computations.

### BRIEF DESCRIPTION OF THE DRAWINGS

FIG. 1 illustrates a system for performing a sparse computation as a dense computation according to some embodiments.

FIG. 2 illustrates a process for performing a sparse computation as a dense computation according to some embodiments.

FIG. 3 illustrates a compiling framework for dynamic sparsity according to some embodiments.

FIG. 4 illustrates four STiles that each have the same dense computation tile according to some embodiments.

FIG. 5 illustrates a sparse kernel skeleton according to some embodiments.

FIG. 6 depicts a simplified block diagram of an example computer system.

### DETAILED DESCRIPTION

Described herein are systems and methods for performing dynamic sparse computation on dense computation efficient computing devices. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein. Although many of the embodiments described herein will reference DNN models, it is to be understood by those skilled in the art that these techniques may be applied to different types of DNN, artificial neural networks (ANN), convolutional neural networks (CNN), as well as other types of neural networks (NN).

In some embodiments, a computing system hosts a compiling framework configured to execute DNN models. The DNN model can consist of tensors which are a data structure for storing data (both input and output) and operators for performing operations on the tensors. A sparse tensor is a tensor that stores data in a sparse format having zero and non-zero values. In contrast, a dense tensor is a tensor that stores data in a dense format that does not have zero values. Some DNN models are dynamically sparse which means that the DNN model includes sparse tensors with varying sparsity. In a DNN model with dynamic sparsity, a tensor's sparsity is only known at runtime. For example, in natural language processing, each sentence may have varying lengths so therefore, zero values may be padded to sentences so that all sentences have the same sequence length for processing. Since the padding in each sentence may change dynamically, this is an example of dynamic sparsity. As another example in image classification, dynamic masks may be applied to mask out the irrelevant background so that the model can achieve high accuracy with less computation. Since the masks are dynamically changing based on the area of interest which changes depending on the item we are attempting to classify (a mask of a dog if you are identifying a dog and a mask of a cat if you are identifying a cat), this is another example of dynamic sparsity.

In some embodiments, the framework for processing a dynamically sparse DNN model starts with a data permutation stage that calls on a primitive function SLoad to transform data that is in a sparse format (i.e., sparse tensor) into data that is in a dense format (i.e., dense tensor). Processing then continues with a data computation stage which may utilize well optimized implementations of dense computation to process the dense tensor. The dense computation may be equivalent to a computation on the sparse tensor. After the dense computation is complete, processing continues by calling a primitive function SWrite to transform the produced dense tensor back to a desired output format. The desired output format may be a sparse format or may be a dense format. This framework allows sparse computation to directly benefit from efficient computation kernels for dense computation. These computing devices may be a central processing unit (CPU), a graphics processing unit (GPU), other processor, or a combination of the above such as a GPU accelerator which is a combination of a GPU in addition to a CPU. In some examples, SLoad is called when data is moved from global memory to shared memory to reduce additional overhead when compared to a sparse computation. Global memory is generally lower hierarchy and is slower performance, such as D-RAM. In contrast, shared memory is faster performance, such as L1/L2 cache.

In some embodiments, techniques described herein allow permutation on finer-grained granularity instead of the whole row or column of a tensor by combining computation tiling and data permutation. For example, with a tensor of size [1024,1024], a computation can be performed on a portion of the column 32×1 instead of the whole column 1024×1. In some embodiments, computation tiling can first be applied to tile an operator into smaller pieces of computation (i.e., a computation tile). Data permutation can then be applied on each computation tile independently to compact the computation tile. In one example, data permutation compacts a sparse computation tile (i.e., a computation tile with zero values) by removing zero values from the computation tile, thereby creating a dense computation tile which is more compact in size. In some embodiments, a sparse tile, or STile, may define how to transform a sparse tensor into a dense tensor. The STile includes a sparsity pattern. The sparsity pattern defines the dimensions of a data tile which will be used to segment the data in the sparse tensor during the permutation to a dense tensor. For example, with a sparsity pattern of [1,5] would segment data in the sparse tensor into blocks having dimensions [1,5]. There are various sparsity patterns in STiles depending on both the feasible permutations of an operator and the size of the computation tile.

In one embodiment, the STile splits sparse computation (i.e., the computation of sparse tensors) into two decoupled stages: data permutation and dense computation. The decoupling allows the dense computation stage to remain free from handling the intricate encoding and decoding of sparse tensors, thus, the dense computation can more efficiently utilize some accelerators (e.g., GPU). With the decoupled stages, solutions described herein may utilize a wide range of well-optimized implementations of dense computation, including hardware instructions (e.g., TensorCore's wmma), manually optimized kernels (e.g., OpenAI's block sparse kernels), and automatically tuned kernels (e.g., AutoTVM).

Dynamic sparsity may benefit from efficient online processing of sparse tensors. In some embodiments, the sparsity may be captured online and translated to efficient computation. Sparsity index (e.g., CSR, BCSR) for the captured sparse tensors may be constructed efficiently by leveraging permutation invariant. Permutation invariant allows the index to be constructed in an out-of-order manner, eliminating heavy synchronization. The computation is performed following the index, with STiles being constructed online. No additional data conversion and copy are performed, leading to very efficient online processing. In some examples, the solutions described herein may be implemented on PyTorch.

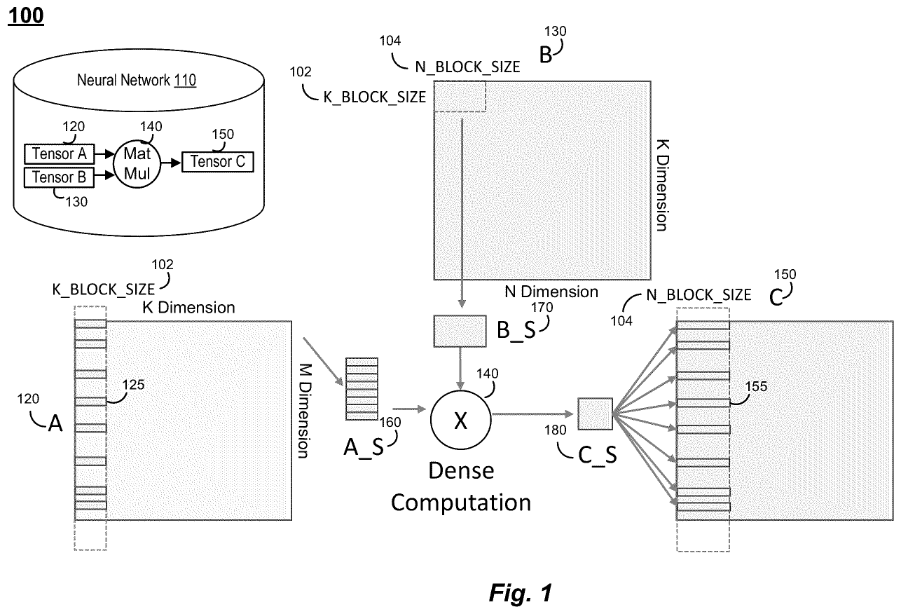

FIG. 1 illustrates a system for performing a sparse computation as a dense computation according to some embodiments. In some embodiments, it may be beneficial to execute the computation as a dense computation because the hardware of the system includes computing devices such as accelerators that are well optimized for dense computation. As shown, system 100 includes neural network 100. Neural network 100 includes operator 140 which is a matrix multiplication. In other examples, operator 140 can be other operations common in a neural network. Operator 140 receives Tensor A 120 and Tensor B 130 as inputs and outputs Tensor C 150 as output.

As shown in the expanded view of system 100, Tensor A 120 has data stored in a sparse format. Tensor A 120 includes rectangular blocks such as block 125 that illustrate the location of non-zero values or values of interest in Tensor A 120. The other locations within Tensor A 120 contain zero values. Tensor B 130 has data stored in a dense format since Tensor B 130 is complete with non-zero values.

In some embodiments, a permutation may be performed on tensors A 120 and B 130 to compact them. The permutation may translate the data within the tensors A 120 and B 130 so that they are stored in a dense format for dense computation. This may be advantageous if the computing system processing neural network 110 includes computing devices that are optimized for dense computation. In one embodiment, the system may first determine which dimension or dimensions in the operator that are permutation invariant and then compact the tensors along the one or more permutation invariant dimensions. Compacting along a permutation invariant dimension ensures that the resulting dense computation performed is accurate. A STile which was generated base ahead of time from operator 140 and a few samples of Tensor A 120 defines sparsity pattern 102 that is going to be applied to Tensor A.

Here, sparsity pattern 102 which is [1,5] is applied to Tensor A 120 as it is compacted across the M dimension. The result is dense computation tile 160, which is a dense representation of Tensor A 120. A similar permutation is performed to Tensor B 130 to generate dense computation tile 170, which is a dense representation of Tensor B 130.

A dense computation can then be performed between dense computation tile 160 and dense computation tile 170, resulting in dense computation tile 180. In some embodiments, a reverse permutation may be performed to rearrange dense computation tile 180 into a desired output format. As shown here, dense computation tile 180 may be rearranged into output tensor C which is in a sparse format. By taking advantage of data permutation and identification of permutation invariant dimensions, a sparse computation can be performed efficiently on a computing device configured for dense computations.

Permutation invariant means that the values in a tensor can be permuted along a certain dimension(s) while the original computation on the permuted tensor is still mathematically correct. For example, in matrix multiplication (Matmul) whose tensor expression is C[m,n]+=A[m,k]*B[k,n], the columns of A along with the rows of B (i.e., the k dimension) can be permuted to any order without affecting the computation result. The rows of A along with the rows of C (i.e., the m dimension) can also be permuted without affecting the computation. Permutation invariant is enabled by two characteristics of the deep learning computations in tensor expression: first, the computations of reduction (e.g., the k dimension in Matmul) is commutative; second, the computations of the values in an output tensor (e.g., C in Matmul) are spatially commutative (e.g., along m or n dimension). Permutation invariant establishes a natural connection between sparse computation and dense computation. In some embodiments, permutation may allow non-zero values or values which that are not of interest to be compacted from a sparse tensor into a smaller dense tensor.

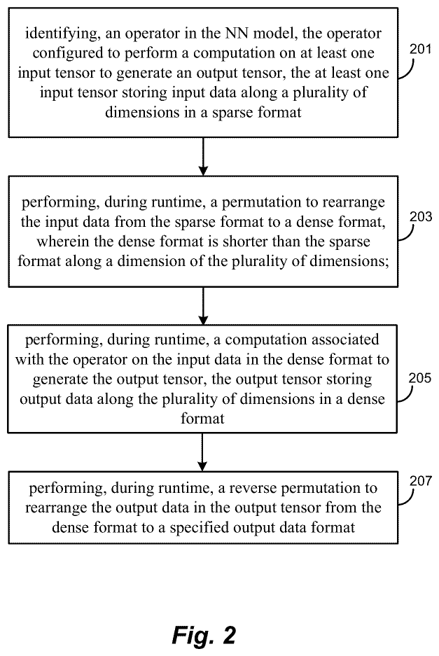

FIG. 2 illustrates a process for performing a sparse computation as a dense computation according to some embodiments. Process 200 can be stored as a computer program in non-transitory computer-readable medium to be executed by one or more processors. For example, process 200 can be executed by a GPU.

Process 200 begins by identifying an operator in the NN model at 201. The operator may be configured to perform a computation on at least one input tensor to generate an output tensor. The at least one input tensor may store input data along a plurality of dimensions in a sparse format. In one example, the operator may be a MatMul having two input tensors and one output tensor.

Next process 200 performs, during runtime, a permutation to rearrange the input data from the sparse format to a dense format at 203. In some embodiments, the permutation may be compact the input data along a dimension of the input tensor that is permutation invariant. As a result, the dense format will be shorter than the sparse format along the permutation invariant dimension. Permutating along the permutation invariant dimension maintains the accuracy of the output tensor after the computation is performed as a dense computation. The dense format may be compact the input data by removing non-zero values from the input tensor.

Next process 200 performs, during runtime, a computation associated with the operator on the input data in the dense format to generate the output tensor at 205. The output tensor may store the output data in a dense format. The computation performed may be a dense computation that is optimized to be performed on a GPU or other computing device.

Lastly, process 200 performs, during runtime, a reverse permutation to rearrange the output data in the output tensor from the dense format to a specified output data format at 207. The reverse permutation may rearrange the output data in the output tensor from the dense format to a specified output data format. The specified output data format may be a dense format or a sparse format.

In some embodiments, a compiling framework is described for processing NN models having dynamic sparsity. The compiling framework may identify one or more dimensions in a tensor expression associated with an operator that are permutation invariant. Permutation invariant dimensions can be compacted during the permutation from sparse format to dense format without affecting the accuracy of the output of the operator. The compiling framework may also utilize a Sparse-Dense Transform by applying permutation invariant on sparse data to build the connection between sparse computation and dense computation. The STile may be used in the Sparse-Dense Transform.

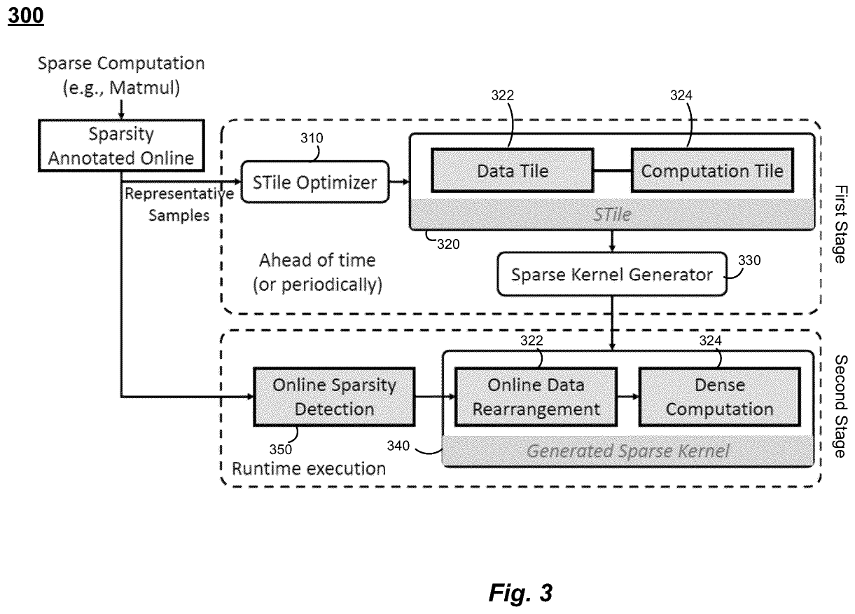

FIG. 3 illustrates a compiling framework for dynamic sparsity according to some embodiments. As shown, framework 300 includes two stages to optimize the execution of a dynamically sparse model. The first stage is to learn the sparsity distribution from only a few samples. Framework 300 includes STile optimizer 310 which analyzes the sparsity of each operator within the model and selects the most suitable STile 320 from a set of pre-constructed STiles. Thus, each operator of the model is associated with a STile. STile 320 includes data tile 322 and computation tile 324. Data tile 322 may describe the size of the block to segment the input tensor when searching for the non-zero values in the input tensor. This may describe the sparsity granularity of the tensor. Computation tile 324 may describe the size of the dense computation tile after permutation of the input tensor. The size of the dense computation tile may be used for the dense computation. Based on the STile 320, sparse kernel generator 330 generates sparse kernel 340. Each operator of the model is associated with an STile and thus is associated with a sparse kernel. Sparse kernel 340 includes primitives for online data rearrangement 322 and dense computation 324. Online data rearrangement 322 rearranges the sparse data into dense format when loading data across different memory hierarchies (e.g., from global memory to shared memory of GPU). Dense computation 324 applies the dense computation on the sparse data in dense format without knowing their indices. In other embodiments, sparse kernel 340 includes a SLoad primitive for permutating a sparse tensor into a dense tensor, a dense computation primitive for performing a dense computation on one or more dense tensors, and a SWrite primitive for reverse permutating a dense tensor into a sparse tensor. In some examples, the first stage can be executed during the initialization, and can also be executed periodically. Periodic execution can help address possible shifting of sparsity distribution.

The second stage of framework 300 is applying the sparse kernel 340 at runtime. To deal with the dynamically changed sparsity, framework 300 includes online sparsity detection 350 which detects the sparsity in real time and builds a sparsity index of the sparse tensor according to the STile. For example if the STile included a data tile that has dimensions [1,5], then online sparsity detection 350 would segment the sparse tensor into blocks of size [1,5] and then generate a sparsity index identifying the blocks within the sparse tensor that contain non-zero values or values of interest. Once the sparsity index has been generated, sparse kernel 340 may permutate the data from the sparse format into a dense format by performing online data rearrangement 322 and then perform the dense computation 324. In some embodiments, sparse kernel 340 further includes an additional primitive for performing a reverse permutation to translate the data from the dense format to a desired output format, such as a sparse format.

Tensor Expression (TE) may be used to describe deep learning computation in existing deep learning compilers. Tensor expression may describe how each element in the output tensor is computed from the corresponding elements of input tensors. Tensor expression can cover most operators for deep learning models. Table 1 below lists some commonly used TEs for deep learning computation.

TABLE 1
Example tensor expressions.

| Operator | Tensor Expression |
|---|---|
| ReduceSum | C[p] += A[p, l] |
| Addition | C[p] = A[p] + B[p] |
| MatMul | C[m, n] += A[m, k] = B[k, n] |
| BatchMatmul | C[b, m, n] += A[b, m, k] * B[b, k, n] |
| Convolution | C[n, f, x, y] += A[n, m, x + i, y + j] * B[f, m, i, j] |

As shown in Table 1, tensor expressions include dimensions. Dimensions describe how data is accessed. For example a MatMul operator includes dimensions m, n, and k. While the data is often consecutively iterated, in some instances the order of data access along a dimension does not affect computation correctness. This type of dimension where data may be accessed non-consecutively is called permutation invariant dimension. Permutation invariant is defined as follows:
Definition: In a tensor expression Y←f(X1, . . . ,Xn), where f is an operator, Xi and Y are its input and output tensors respectively. A dimension k in the operator is permutation invariant if it satisfies:

∀P∈Φk, ∃P′∈Φk

s.t.P′(f(P(X1), . . . ,P(Xn))=Y,

where Φk is the set of all permutation functions on k dimension. P (X) means a permutation function P is applied on the k dimension of the tensor X, to shuffle the elements on k dimension to a new order. If k dimension does not exist in X, P(X)=X.

In other words for a permutation invariant dimension (e.g., m in MatMul), when permutation is applied on this dimension of the input tensor (e.g., A in MatMul), there exists a reverse permutation on the output tensor (e.g., C in Matmul) to make the result the same as the original computation.

Permutation invariant dimensions are ubiquitous in deep learning computations and can be classified into three categories: sporadic dimension, prevalent dimension, and compound dimension. 1) Sporadic dimension is the dimension that exists in one or more tensors of a tensor expression, but does not span in all tensors. For example, m, n, k, f, l of the tensor expressions in Table 1 are sporadic dimension. 2) Prevalent dimension is the dimension that exists in all the tensors (i.e., input and output tensors) of a tensor expression. Examples of prevalent dimension are p and b in Table 1. 3) Compound dimension is the dimension that is involved in an arithmetic expression. For example in Table 1, x and i in Convolution are involved in the arithmetic expression x+i. Similarly, y and j are involved in y+j. Thus, x, y, i, and j are compound dimensions.

Permutation invariant may follow different application rules depending on the type of dimension and the number of dimensions. When permutation invariant is applied on only one dimension of a tensor expression, the dimension can be sporadic dimension or prevalent dimension, but not compound dimension. This is because permuting a compound dimension violates its corresponding arithmetic expression. When permutation invariant is applied on multiple dimensions of a tensor expression, there are two application rules: 1) When the permuted dimensions are all sporadic dimension, each dimension can only have a single permutation function. For example, a tensor X[i, j] where i and j are sporadic dimension, the permutation function for each vector X[i, :] (i.e., on j dimension) should be the same. 2) When the permuted dimensions include a prevalent dimension, the permutation function on each element of the prevalent dimension could be different. For example, a tensor X[i, j] where i is prevalent dimension, the permutation function for each vector X[i, :] can be different. This is because the computation on each element of prevalent dimension has no data dependency.

In some embodiments, permutation invariance provides opportunities to leverage dense computation kernels for sparse computation. For example in a dimension k of a MatMul tensor expression, if some of its elements are dropped (masked), this dimension may be defined as a sparse dimension and the dropped elements may be considered redundant elements. With permutation invariant, a permutation function P can be constructed to move all the redundant elements to the end of the k dimension so that all the non-redundant elements are moved the front. Then the redundant elements can be safely removed to build a shorter k dimension. Such transformation is denoted as Sparse-Dense Transform as it builds a connection between sparse and dense computation.

In some embodiments, the Sparse-Dense Transform may be applied in the granularity of the tile level. A tile is a sliced piece of an operator's computation. Commonly, computation tiling slices the computation into many small homogeneous pieces, to parallelize the computation and increase data reuse. For example, a MatMul of the shape A[64,64]*B[64,64] can be sliced into 16 tiles, each of which is a smaller MatMul of the shape A[16,64]*B[64,16]. Sparse-Dense Transform can be applied on each tile independently. This allows each tile to potentially have a different permutation function which leads to more diverse and fine-grained sparsity granularity.

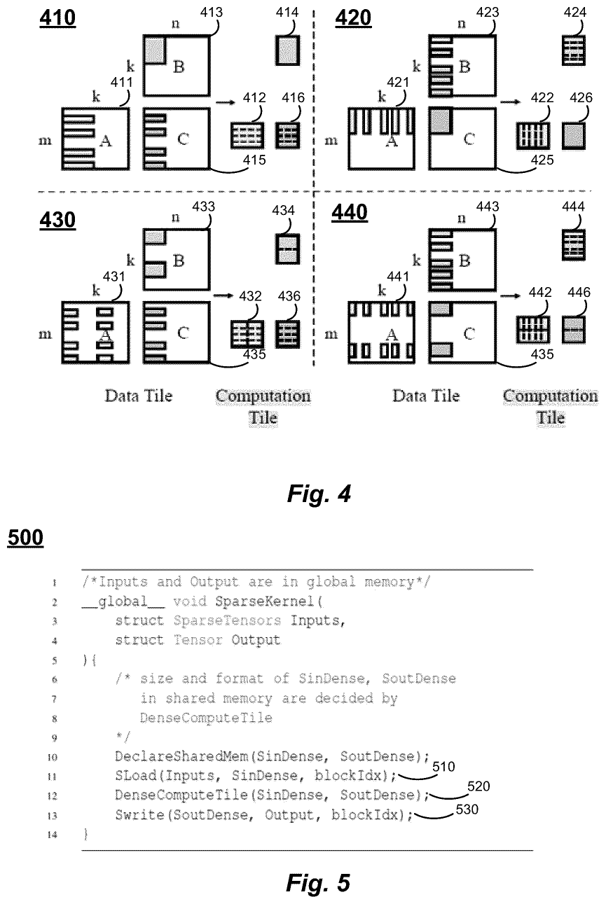

As mentioned above, a STile provides a way for transforming a data in a sparse format to data in a dense format. The STile can include a group of non-redundant elements following a specific type of layout, associated with a dense computation tile. The non-redundant element is called the data tile which represents the sparsity granularity. The scattered data tiles can be condensed to be a dense computation tile. In reverse, a dense computation tile can correspond to different STiles with different permutation functions. A reverse permutation function may be utilized by the STile to transform from the dense computation tile to a sparse computation tile. FIG. 4 illustrates four STiles that each have the same dense computation tile according to some embodiments. Here, the dense computation tile is TC=TA*TB, whose shapes are [4,3]=[4,5]*[5,3]. As shown in STile 410 on the top left of FIG. 4, the rows of tensor A 411 are scattered in non-continuous rows. The data tile of this STile is the size of tensor A 411's one row (i.e., 1×5), which can be seen as the effective sparsity granularity. As shown in STile 410, tensor A 411 has four data tiles, each of size 1×5. The data tiles of tensor A 411 can be condensed to dense tensor 412 during loading from lower-level to upper-level memory (e.g., from global memory to shared memory). Similarly, tensor B 413 has a data tile of size 5×3. Tensor B 413 may be condensed to dense tensor 414. A dense computation is then performed between dense tensors 412 and 414 to generate dense tensor 416.

Now looking at STile 420, the shape of the data in tensor A 421 is in vertical blocks so data tile for STile 420 is 4×1. STile 420 contains five data tiles of size 4×1. A permutation function can be applied to tensor A 421 on the k dimension to generate dense computation tile 422. A permutation function can also be applied on tensor B 423 also on the k dimension to generate dense computation tile 424. A dense computation can then be performed between dense tensors 422 and 424 to generate dense computation tile 426.

In STile 430 and STile 440, the data tiles are smaller in size where dimensions m and k both have their own permutation functions. In other words, a permutation is taking place across two dimensions of the tensor A due to the sparsity granularity of the data in tensor A. In STile 430, two permutation functions across the m and k dimension are performed on tensor A 431 to generate dense computation tile 432. One permutation function across the k dimension is performed on tensor B 433 to generate dense computation tile 434. A dense computation is then performed on dense computation tiles 432 and 434 to generate dense computation tile 436. In STile 440, two permutation functions across the m and k dimension are performed on tensor A 441 to generate dense computation tile 442. One permutation function across the k dimension is performed on tensor B 443 to generate dense computation tile 444. A dense computation is then performed on dense computation tiles 442 and 444 to generate dense computation tile 446.

The design of STile naturally decouples sparse data (i.e., the data tiles) encoding/decoding and computation. The computation (i.e., computation tile) operates on dense data without traditional sparse data indexes, which greatly improves computation efficiency. In one embodiment, the preparation of the dense computation tiles 412, 422, 432, and 442 happen on the fly during data movement across memory hierarchies.

In some embodiments, a sparse kernel can be generated based on a STile. The sparse kernel may include primitive functions for the data rearrangement phase (either into dense format or out of dense format) and the dense computation phase. In one embodiment, the sparse kernel can include two primitives SLoad and SWrite for the data rearrangement. SLoad may be configured to perform a permutation or transform data in input tensors from a sparse format to a dense format while SWrite may be configured to perform a reverse permutation or transform to writes data in an output tensor that is in a dense format to a specified output data format, which could be sparse or dense. FIG. 5 illustrates a sparse kernel skeleton according to some embodiments. As shown, sparse kernel 500 includes SLoad function 510. SLoad function 510 receives an input tensor, permutates the data in the input tensor into a dense format, and outputs the permutated data as a dense computation tile SinDense. Sparse kernel 500 further includes DenseComputeTile function 520. DenseComputeTile function 520 receives SinDense, performs a dense computation on SinDense to generate output data in a dense format, and outputs the output data as a dense computation tile SoutDense. Sparse kernel 500 further includes SWrite function 530. SWrite function receives SoutDense, performs a reverse permutation on SoutDense so that the data is in the specified output format, and the outputs the data in said output format as Output. SLoad and SWrite are the additional overhead in the sparse kernel when compared to simply performing a dense computation in a dense kernel. However, the additional overhead may be minimized or eliminated by leveraging the memory hierarchy of modern devices.

In some embodiments, SLoad and SWrite may be utilized for data rearrangement when the data is moving from global memory to shared memory and in reverse. When applied as data is moving between global memory and shared memory, the data rearrangement would introduce little to no overhead so long as the data tile could saturate read/write transaction of the memory (e.g., 32 bytes in CUDA GPUs) because the loading of sparse data tiles does not waste memory bandwidth. Thus, its performance almost equals to that of moving data across memory hierarchies in traditional dense computation. This property further enables zero-copy of sparse data in online dynamic sparsity scenario, because the effective data tiles can be directly selected from their original data format and written to the higher level memory with the desired format.

As shown in FIG. 4, there are various STiles. In online dynamic sparsity, the most suitable STile can be selected based on several representative sparsity samples. Algorithm 1 below shows an example of an optimization process. Algorithm 1 traverses all the STiles in the tile database to compute their cost on the given dynamically sparse operator and picks the best. Specifically, CoverAlgo (line 6) outputs the number of STiles needed to cover all the non-zero values of a given sparsity sample. The cost is the sum of the n sparsity samples.

ALGORITHM 1
Optimizing STile kernel for a dynamically sparse operator.

| | Data: Op: A dynamically sparse operator, | | | |
|---|---|---|---|---|
| | | Dₛₚₐᵣₛₑ: A list of n sparsity samples of Op. | | |
| | Result: Bestₛₜᵢₗₑ: The best STile for Op. | | | |
| 1 | Function ChooseStile(Dₛₚₐᵣₛₑ, Op): | | | |
| 2 | \| | Bestₛₜᵢₗₑ = null; Costₒₚₜᵢₘₐₗ = inf; | | |
| 3 | \| | foreach S ∈ GetStilesFromTileDB(Op) do | | |
| 4 | \| | \| | Cost = 0; | |
| 5 | \| | \| | foreach D ∈ Dₛₚₐᵣₛₑ do | |
| 6 | \| | \| | \| | Numₛₜᵢₗₑₛ = CoverAlgo(D, S.data_tile); |
| 7 | \| | \| | \| | Cost += Numₛₜᵢₗₑₛ * S.tile_cost; |
| 8 | \| | \| | if Cost < Costₒₚₜᵢₘₐₗ then | |
| 9 | \| | \| | \| | Bestₛₜᵢₗₑ = S; |
| 10 | \| | \| | \| | Costₒₚₜᵢₘₐₗ = Cost; |

| | | |
|---|---|---|
| 11 | \| | return Bestₛₜᵢₗₑ; |

STile is the building block of the computation. To deal with dynamically changing sparsity, the sparsity should be captured online and translated to STile. To facilitate this online process, we propose an enhanced representation of dynamic sparsity, which is for users to specify the sparsity of the tensors in each forward pass of model execution.

In some embodiments, the representation of dynamic sparsity is a sparsity attribute that can be efficiently constructed and parsed while consuming less memory. The sparsity attribute may be stored as a 0-1 attribute matrix along with a sparsity granularity. Each value in the attribute matrix represents the existence of a data tile which is the size of the sparsity granularity. For example, if the sparsity granularity is of size 1×5, then each value in the attribute matrix associated with tensor A would represent the existence of a data tile having non-zero values that is of size 1×5. In some embodiments, the attribute matrix may represent different types of dynamic sparsity. One type is that the location of sparse values keeps changing while the granularity is the same (e.g., in model pruning). Another type allows the granularity to change. For example, to specify the sparsity of a batch of sentences with different lengths, the sparsity attribute may allow each sentence to have its own granularity, i.e., 1×L where L is the length of this sentence. Thus, the sparsity attribute representing the sparsity granularity is in the form of (Sdim1, . . . ,SdimN), where Sdim is the size of the granularity on dimension dim. The representation not only makes the sparsity attribute much smaller, but also aligns with the design of Sparse-Dense Transform which transforms data along dimensions.

In one embodiment, the compiling framework detects the annotated sparsity and builds the index of the non-zero blocks in every sparse tensor during runtime model execution. The non-zero blocks are in the granularity of the data tile of the chosen STile in Algorithm 1. The blocks are translated into a plurality of STiles in an online, also known as runtime, manner. The design of STile accelerates the index construction and the computation translation. The compiling framework may construct the sparsity index in an out-of-order manner because the permutation invariant property relaxes the order of the indices in a sparse data format. For example in BCSR, the column indices of non-zero elements in each row should be ordered, which creates considerable synchronization overhead especially in GPU accelerators. Permutation invariant allows the column indices to be written in any order and therefore eliminates the synchronization overhead. In one embodiment, the compiling framework constructs an index while leaving the data as is. The index directly references the data blocks in their original tensor. STile uses the index to load the data blocks across memory hierarchies (e.g., from global memory to shared memory in GPU) and rearranges the data blocks on-the-fly into the dense format. This can greatly reduce the overhead of data conversion (e.g., from dense format to BCSR), enabling zero-copy data rearrangement.

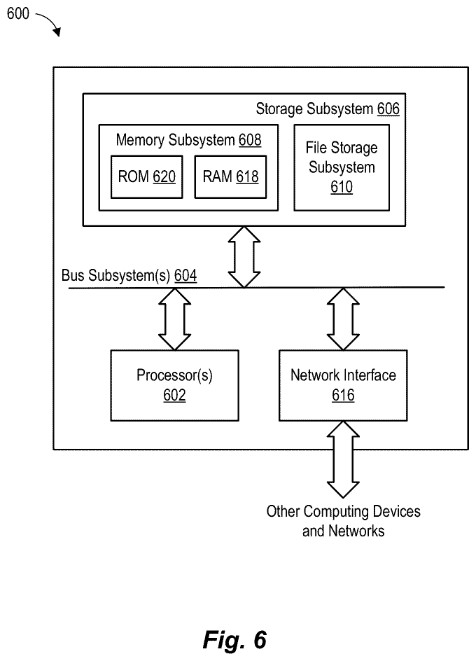

FIG. 6 depicts a simplified block diagram of an example computer system 600, which can be used to implement some of the techniques described in the foregoing disclosure. As shown in FIG. 6, system 600 includes one or more processors 602 that communicate with a number of devices via one or more bus subsystems 604. These devices may include a storage subsystem 606 (e.g., comprising a memory subsystem 608 and a file storage subsystem 610) and a network interface subsystem 616. Some systems may further include user interface input devices and/or user interface output devices (not shown).

Bus subsystem 604 can provide a mechanism for letting the various components and subsystems of system 600 communicate with each other as intended. Although bus subsystem 604 is shown schematically as a single bus, alternative embodiments of the bus subsystem can utilize multiple busses.

Network interface subsystem 616 can serve as an interface for communicating data between system 600 and other computer systems or networks. Embodiments of network interface subsystem 616 can include, e.g., Ethernet, a Wi-Fi and/or cellular adapter, a modem (telephone, satellite, cable, etc.), and/or the like.

Storage subsystem 606 includes a memory subsystem 608 and a file/disk storage subsystem 610. Subsystems 608 and 610 as well as other memories described herein are examples of non-transitory computer-readable storage media that can store executable program code and/or data that provide the functionality of embodiments of the present disclosure.

Memory subsystem 608 comprise one or more memories including a main random access memory (RAM) 618 for storage of instructions and data during program execution and a read-only memory (ROM) 620 in which fixed instructions are stored. File storage subsystem 610 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that system 600 is illustrative and many other configurations having more or fewer components than system 600 are possible.

### Further Examples

Each of the following non-limiting features in the following examples may stand on its own or may be combined in various permutations or combinations with one or more of the other features in the examples below. In various embodiments, the present disclosure may be implemented as a processor or method.

In some embodiments the present disclosure includes a system for processing data in a Neural Network (NN) model comprising: one or more processors; a non-transitory computer-readable medium storing a program executable by the one or more processors, the program comprising sets of instructions for: identifying, an operator in the NN model, the operator configured to perform a computation on at least one input tensor to generate an output tensor, the at least one input tensor storing input data along a plurality of dimensions in a sparse format; performing, during runtime, a permutation to rearrange the input data from the sparse format to a dense format, wherein the dense format is shorter than the sparse format along a dimension of the plurality of dimensions; and performing, during runtime, a computation associated with the operator on the input data in the dense format to generate the output tensor, the output tensor storing output data along the plurality of dimensions in a dense format; and performing, during runtime, a reverse permutation to rearrange the output data in the output tensor from the dense format to a specified output data format; wherein the instructions to perform the permutation, the computation, and the reverse permutation are defined as primitives in a sparse kernel.

In some embodiments, the present disclosure includes a method for processing data in a Neural Network (NN) model comprising: identifying, an operator in the NN model, the operator configured to perform a computation on at least one input tensor to generate an output tensor, the at least one input tensor storing input data along a plurality of dimensions in a sparse format; performing, during runtime, a permutation to rearrange the input data from the sparse format to a dense format, wherein the dense format is shorter than the sparse format along a dimension of the plurality of dimensions; and performing, during runtime, a computation associated with the operator on the input data in the dense format to generate the output tensor, the output tensor storing output data along the plurality of dimensions in a dense format; and performing, during runtime, a reverse permutation to rearrange the output data in the output tensor from the dense format to a specified output data format; wherein the instructions to perform the permutation, the computation, and the reverse permutation are defined as primitives in a sparse kernel.

In some embodiments, the present disclosure includes a non-transitory computer-readable medium storing a program executable by one or more processors, the program comprising sets of instructions for: identifying, an operator in the NN model, the operator configured to perform a computation on at least one input tensor to generate an output tensor, the at least one input tensor storing input data along a plurality of dimensions in a sparse format; performing, during runtime, a permutation to rearrange the input data from the sparse format to a dense format, wherein the dense format is shorter than the sparse format along a dimension of the plurality of dimensions; and performing, during runtime, a computation associated with the operator on the input data in the dense format to generate the output tensor, the output tensor storing output data along the plurality of dimensions in a dense format; and performing, during runtime, a reverse permutation to rearrange the output data in the output tensor from the dense format to a specified output data format; wherein the instructions to perform the permutation, the computation, and the reverse permutation are defined as primitives in a sparse kernel.

In one embodiment, the permutation to rearrange the input data from the sparse format to the dense format is performed when the input data is being loaded from general memory to stored memory.

In one embodiment, the reverse permutation to rearrange the output data from the dense format to output data in the sparse format is performed when the output data is being stored from shared memory to general memory.

In one embodiment, the program further comprises instructions for: generating a sparsity index configured to identify the location of non-zero values within the input data in the input tensor, the sparsity index based on a sparse tile.

In one embodiment, the program further comprises instructions for: analyzing the sparsity of the operator; selecting the sparse tile from a plurality of pre-constructed sparse tiles based on the sparsity; and generating the sparse kernel based on the selected sparse tile.

In one embodiment, the analyzing, the selecting, and the generating occur prior to runtime.

In one embodiment, the sparse kernel includes a data tile describing the shape of data in the input tensor and a computation tile describing the shape of the dense format.

In one embodiment, the sparse tile identifies the dimension of the plurality of dimensions as being permutation invariant.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A system for processing data in a Neural Network (NN) model comprising:
one or more processors;
a non-transitory computer-readable medium storing a program executable by the one or more processors, the program comprising sets of instructions for:
identifying an operator in the NN model, the operator configured to perform a computation on at least one input tensor to generate an output tensor, the at least one input tensor storing input data along a plurality of dimensions in a sparse format;
performing, during runtime, a permutation to rearrange the input data from the sparse format to a dense format, wherein the dense format is shorter than the sparse format along a dimension of the plurality of dimensions;
performing, during runtime, a computation associated with the operator on the input data in the dense format to generate the output tensor, the output tensor storing output data along the plurality of dimensions in a dense format; and
performing, during runtime, a reverse permutation to rearrange the output data in the output tensor from the dense format to a specified output data format;
wherein the instructions to perform the permutation, the computation, and the reverse permutation are defined as primitives in a sparse kernel.

2. The system of claim 1, wherein the permutation to rearrange the input data from the sparse format to the dense format is performed when the input data is being loaded from general memory to stored memory.

3. The system of claim 2, wherein the reverse permutation to rearrange the output data from the dense format to output data in the sparse format is performed when the output data is being stored from shared memory to general memory.

4. The system of claim 1, wherein the program further comprises instructions for: generating a sparsity index configured to identify the location of non-zero values within the input data in the input tensor, the sparsity index based on a sparse tile.

5. The system of claim 4, wherein the program further comprises instructions for:
analyzing the sparsity of the operator;
selecting the sparse tile from a plurality of pre-constructed sparse tiles based on the sparsity; and
generating the sparse kernel based on the selected sparse tile.

6. The system of claim 5, wherein the analyzing, the selecting, and the generating occur prior to runtime.

7. The system of claim 5, wherein the sparse kernel includes a data tile describing the shape of data in the input tensor and a computation tile describing the shape of the dense format.

8. The system of claim 5, where the sparse tile identifies the dimension of the plurality of dimensions as being permutation invariant.

9. A method for processing data in a Neural Network (NN) model comprising:
identifying an operator in the NN model, the operator configured to perform a computation on at least one input tensor to generate an output tensor, the at least one input tensor storing input data along a plurality of dimensions in a sparse format;
performing, during runtime, a permutation to rearrange the input data from the sparse format to a dense format, wherein the dense format is shorter than the sparse format along a dimension of the plurality of dimensions;
performing, during runtime, a computation associated with the operator on the input data in the dense format to generate the output tensor, the output tensor storing output data along the plurality of dimensions in a dense format; and
performing, during runtime, a reverse permutation to rearrange the output data in the output tensor from the dense format to a specified output data format;
wherein the instructions to perform the permutation, the computation, and the reverse permutation are defined as primitives in a sparse kernel.

10. The method of claim 9, wherein the permutation to rearrange the input data from the sparse format to the dense format is performed when the input data is being loaded from general memory to stored memory.

11. The method of claim 10, wherein the reverse permutation to rearrange the output data from the dense format to output data in the sparse format is performed when the output data is being stored from shared memory to general memory.

12. The method of claim 9, wherein the program further comprises instructions for: generating a sparsity index configured to identify the location of non-zero values within the input data in the input tensor, the sparsity index based on a sparse tile.

13. The method of claim 12, wherein the program further comprises instructions for:
analyzing the sparsity of the operator;
selecting the sparse tile from a plurality of pre-constructed sparse tiles based on the sparsity; and
generating the sparse kernel based on the selected sparse tile.

14. The method of claim 13, wherein the analyzing, the selecting, and the generating occur prior to runtime.

15. The method of claim 13, wherein the sparse kernel includes a data tile describing the shape of data in the input tensor and a computation tile describing the shape of the dense format.

16. The method of claim 13, where the sparse tile identifies the dimension of the plurality of dimensions as being permutation invariant.

17. A non-transitory computer-readable medium storing a program executable by one or more processors, the program comprising sets of instructions for:
identifying an operator in the NN model, the operator configured to perform a computation on at least one input tensor to generate an output tensor, the at least one input tensor storing input data along a plurality of dimensions in a sparse format;
performing, during runtime, a permutation to rearrange the input data from the sparse format to a dense format, wherein the dense format is shorter than the sparse format along a dimension of the plurality of dimensions;
performing, during runtime, a computation associated with the operator on the input data in the dense format to generate the output tensor, the output tensor storing output data along the plurality of dimensions in a dense format; and
performing, during runtime, a reverse permutation to rearrange the output data in the output tensor from the dense format to a specified output data format;
wherein the instructions to perform the permutation, the computation, and the reverse permutation are defined as primitives in a sparse kernel.

18. The computer readable medium of claim 17, wherein the program further comprises instructions for: generating a sparsity index configured to identify the location of non-zero values within the input data in the input tensor, the sparsity index based on a sparse tile.

19. The computer readable medium of claim 18, wherein the program further comprises instructions for:
analyzing the sparsity of the operator;
selecting the sparse tile from a plurality of pre-constructed sparse tiles based on the sparsity; and
generating the sparse kernel based on the selected sparse tile

20. The computer readable medium of claim 19, wherein the analyzing, the selecting, and the generating occur prior to runtime.
